(19) United States
(12) Patent Application Publication
(10) Pub. No.: US 2026/0351824 A1
(43) Pub. Date: Nov. 5, 2026

(54) ANTENNA AND ELECTRONIC DEVICE

(71) Applicants: Beijing BOE Technology Development Co., Ltd., Beijing (CN); BOE Technology Group Co., Ltd., Beijing (CN)

(72) Inventors: Cheng PAN, Beijing (CN); Shiqiao ZHANG, Beijing (CN); Jia FANG, Beijing (CN); Yu LUO, Beijing (CN); Feng QU, Beijing (CN)

(21) Appl. No.: 19/476,669

(22) PCT Filed: Mar. 13, 2024
(86) PCT No.: PCT/CN2024/081348

§ 371 Date: Oct. 17, 2025

(30) Foreign Application Priority Data
Apr. 19, 2023 (CN) 202310423073.0

(51) Int. Cl. H01P 1/18; H01Q 1/22; H01Q 3/36

(52) U.S. Cl. CPC H01P 1/18; H01Q 1/22; H01Q 3/36

(57) ABSTRACT

The present disclosure provides an antenna and an electronic device, and belongs to the field of communication technology. The antenna of the present disclosure includes a first dielectric substrate and a second dielectric substrate, a phase adjustment structure between the first dielectric substrate and the second dielectric substrate, a reference electrode layer disposed on the first dielectric substrate, and at least one feeding structure; the reference electrode layer includes at least one opening, the phase adjustment structure includes a feeding end, and each feeding structure is electrically connected to the feeding end of the phase adjustment structure through one opening; and each opening includes at least one first sub-structure, and a width of a middle portion of each of at least part of first sub-structures is not greater than a width of each of two ends of the first sub-structure in a length direction of the first sub-structure.

### TECHNICAL FIELD

The present disclosure relates to the field of communication technology, in particular to an antenna and an electronic device.

### BACKGROUND

With the development of modern communication systems, the requirements for integration and low loss of microwave circuits are higher and higher. In a microwave circuit, the requirement of designing microwave component and circuit cannot be satisfied by only one type of transmission line structure. Therefore, each microwave system necessarily includes a plurality of types of transmission lines and microwave components.

In the existing art, taking an antenna based on a liquid crystal phase shifter as an example, it is necessary to apply an electrical signal to a signal transmission line in the antenna through a feeding structure, the feeding structure performs a feeding operation through a slit to achieve an electrical connection between the feeding structure and the signal transmission line, and the design of the slit affects the feeding effect.

### SUMMARY

The present disclosure is directed to at least one of the technical problems in the existing art, and provides an antenna and an electronic device.

In a first aspect, an embodiment of the present disclosure provides an antenna, including a first dielectric substrate and a second dielectric substrate, a phase adjustment structure between the first dielectric substrate and the second dielectric substrate, a reference electrode layer disposed on the first dielectric substrate, and at least one feeding structure; the reference electrode layer includes at least one opening, the phase adjustment structure includes a feeding end, and each feeding structure is electrically connected to the feeding end of the phase adjustment structure through one of the at least one opening; and each of the at least one opening includes at least one first sub-structure, and a width of a middle portion of each first sub-structure in at least part of first sub-structures is not greater than a width of each of two ends of the first sub-structure in a length direction of the first sub-structure.

In some implementations, an orthographic projection of the feeding end on the first dielectric substrate passes through a middle portion of an orthographic projection of one first sub-structure on the first dielectric substrate.

In some implementations, the opening includes two first sub-structures, middle portions of the two first sub-structures intersect with each other, and a width of the middle portion of each first sub-structure in the two first sub-structures is not greater than a width of each of two ends of the first sub-structure in a length direction of the first sub-structure.

In some implementations, the opening is an H-shaped opening.

In some implementations, the H-shaped opening includes three first sub-structures, and a width of a middle portion of each first sub-structure in the three first sub-structures of the H-shaped opening is not greater than a width of each of two ends of the first sub-structure in a length direction of the first sub-structure.

In some implementations, the H-shaped opening includes three first sub-structures, and for the three sub-structures, a width of a middle portion of each first sub-structure in two first sub-structures parallel to each other is not greater than a width of each of two ends of the first sub-structure in a length direction of the first sub-structure.

In some implementations, the H-shaped opening includes three first sub-structures, and for the three sub-structures, a width of a middle portion of the first sub-structure between two first sub-structures parallel to each other is not greater than a width of each of two ends of the first sub-structure in a length direction of the first sub-structure.

In some implementations, the H-shaped opening includes three first sub-structures, and for the three sub-structures, two ends of the first sub-structure between two first sub-structures parallel to each other overlap with middle portions of the two first sub-structures parallel to each other, respectively.

In some implementations, each first sub-structure is a straight-line structure, and includes a first side and a second side extending in a length direction of the first sub-structure and disposed oppositely to each other; and at least one of the first side and the second side is of a curved line or a broken line.

In some implementations, the reference electrode layer is on a side of the first dielectric substrate away from the second dielectric substrate; the antenna further includes a third dielectric substrate, the third dielectric substrate is on a side of the reference electrode layer away from the first dielectric substrate; and the feeding structure is on a side of the third dielectric substrate away from the reference electrode layer.

In some implementations, the phase adjustment structure includes: a first electrode layer on a side of the first dielectric substrate proximal to the second dielectric substrate, a second electrode layer on a side of the second dielectric substrate proximal to the first dielectric substrate, and a tunable dielectric layer between the first electrode layer and the second electrode layer.

In some implementations, the phase adjustment structure includes: a second electrode layer on a side of the first dielectric substrate proximal to the second dielectric substrate, a first electrode layer on a side of the second dielectric substrate proximal to the first dielectric substrate, and a tunable dielectric layer between the first electrode layer and the second electrode layer, and the second electrode layer serves as the reference electrode layer.

In some implementations, the phase adjustment structure includes two feeding ends, including a first feeding end and a second feeding end, and the reference electrode layer includes two openings, including a first opening and a second opening; the at least one feeding structure includes a first feeding structure and a second feeding structure; the first feeding structure is electrically connected to the first feeding end through the first opening, and the second feeding structure is electrically connected to the second feeding end through the second opening; the first electrode layer includes a first transmission structure and a second transmission structure, and a first transmission line and a second transmission line; a main path of the first transmission structure serves as the first feeding end, and two branches of the first transmission structure are respectively connected to a first end of the first transmission line and a first end of the second transmission line; and a main path of the second transmission structure serves as the second feeding end, and two branches of the second transmission structure are respectively connected to a second end of the first transmission line and a second end of the second transmission line; and the second electrode layer includes a plurality of patch electrodes, and an orthographic projection of each of the patch electrodes on the first dielectric substrate overlaps with an orthographic projection of each of the first transmission line and the second transmission line on the first dielectric substrate.

In some implementations, the first transmission line includes a first main line and a plurality of first branches connected on one side of the first main line in an extending direction of the first main line, and the second transmission line includes a second main line and a plurality of second branches connected one one side of the second main line in an extending direction of the second main line; and the orthographic projection of each of the patch electrodes on the first dielectric substrate overlaps with an orthographic projection of each of one first branch and one second branch on the first dielectric substrate.

In a second aspect, an embodiment of the present disclosure provides an electronic device, which includes the antenna described above.

### BRIEF DESCRIPTION OF DRAWINGS

FIG. 1 is a cross-sectional view of an antenna provided by an embodiment of the present disclosure.

FIG. 2 is a cross-sectional view of an antenna provided by an embodiment of the present disclosure.

FIG. 3 is a top view of an antenna provided by an embodiment of the present disclosure.

FIG. 4 is a top view of an antenna provided by an embodiment of the present disclosure.

FIG. 5 is a top view of a phase adjustment structure in an embodiment of the present disclosure.

FIG. 6 is a cross-sectional view taken along a direction A-A′ in FIG. 5.

FIG. 7 is a top view of a phase adjustment structure in an embodiment of the present disclosure.

FIG. 8 is a cross-sectional view taken along a direction B-B′ in FIG. 7.

FIGS. 9 to 13 are top views of an opening provided by an embodiment of the present disclosure.

### DETAIL DESCRIPTION OF EMBODIMENTS

In order to enable one of ordinary skill in the art to better understand the technical solutions of the present disclosure, the present disclosure will be described in further detail with reference to the accompanying drawings and the detailed description.

Unless defined otherwise, technical or scientific terms used herein shall have the ordinary meaning as understood by one of ordinary skill in the art to which the present disclosure belongs. The terms “first”, “second”, and the like used in the present disclosure are not intended to indicate any order, quantity, or importance, but rather are used for distinguishing one element from another. Further, the term “a”, “an”, “the”, or the like used herein does not denote a limitation of quantity, but rather denotes the presence of at least one element. The term of “comprising”, “including”, or the like, means that the element or item preceding the term contains the element or item listed after the term and its equivalent, but does not exclude other elements or items. The term “connected”, “coupled”, or the like is not limited to physical or mechanical connections, but may include electrical connections, whether direct or indirect connections. The terms “upper/on/above”, “lower/below/under”, “left”, “right”, and the like are used only for indicating relative positional relationships, and when the absolute position of an object being described is changed, the relative positional relationships may be changed accordingly.

With the development of modern communication systems, the requirements for integration and low loss of microwave circuits are higher and higher. In a microwave circuit, the requirement of designing microwave component and circuit cannot be satisfied by only one type of transmission line structure. Therefore, each microwave system necessarily includes a plurality of types of transmission lines and microwave components.

Taking an antenna as an example, the antenna includes a first dielectric substrate and a second dielectric substrate, a phase adjustment structure between the first dielectric substrate and the second dielectric substrate, a reference electrode layer disposed on the first dielectric substrate, and at least one feeding structure. The reference electrode layer is provided with at least one opening, and the phase adjustment structure is provided with a feeding end; each feeding structure is electrically connected to the feeding end of the phase adjustment structure through one opening. A waveguide is generally used for feeding, and a transmission scheme such as a metal waveguide, a dielectric waveguide or an air waveguide or the like is common. However, for a signal transmission device using the metal waveguide, it is difficult to be integrated with other electronic devices due to a large volume and a robust structure of the signal transmission device. Although a dielectric integrated waveguide is proposed, for reducing the volume of the waveguide, and resulting in a thinner dielectric waveguide, a great transmission loss is caused by stacking of many dielectric materials in the dielectric integrated waveguide. For the air waveguide, an opening is formed, for feeding, in a layer between the feeding structure and the signal transmission line, in response to the air waveguide being relatively thin, a serious impedance mismatch may occur, so that it is difficult to perform the microwave feeding. The opening, such as a slit, is typically formed in a metal material in the air waveguide. The opening is formed between the feeding structure and the feeding end, and a coupling is achieved through the opening to transmit the electric signal from the feeding structure to the feeding end of the phase adjustment structure, or transmit the electric signal from the phase adjustment structure to the feeding structure. A shape and a width of the opening affect the feeding effect, and thus the opening is desired to be designed to improve the feeding effect and reduce the signal transmission loss.

In view of this, an embodiment of the present disclosure provides an antenna, which includes a first dielectric substrate and a second dielectric substrate, a phase adjustment structure between the first dielectric substrate and the second dielectric substrate, a reference electrode layer disposed on the first dielectric substrate, and at least one feeding structure. The reference electrode layer is provided with at least one opening, and the phase adjustment structure is provided with a feeding end; each feeding structure is electrically connected to the feeding end of the phase adjustment structure through one opening. The opening includes at least one first sub-structure, and a width of a middle portion of each first sub-structure in at least part of first sub-structures is not greater than a width of each of two ends of the first sub-structure in a length direction of the first sub-structure.

The antenna and the electronic device in the present disclosure are further specifically described below with reference to specific implementations and the accompanying drawings.

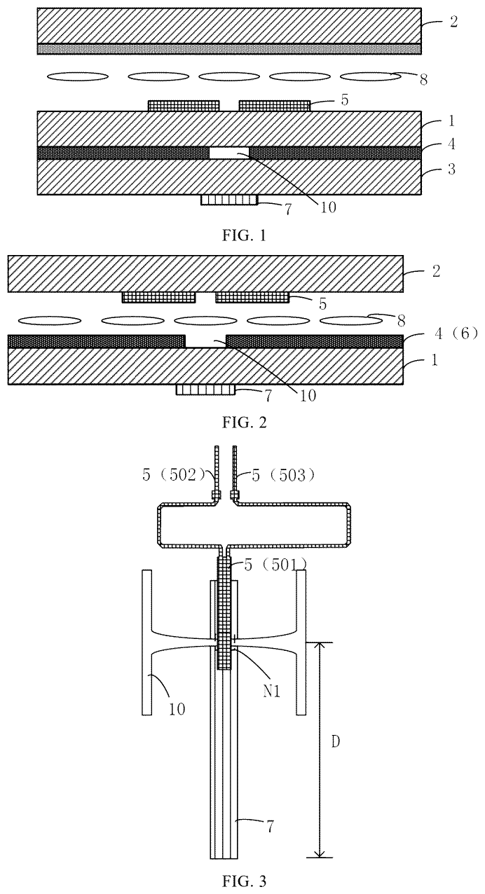

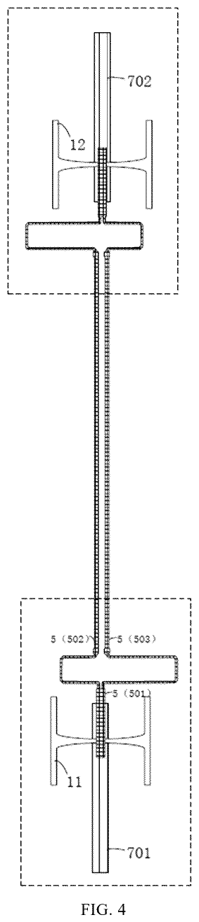

FIG. 1 is a cross-sectional view of an antenna provided by an embodiment of the present disclosure. FIG. 2 is a cross-sectional view of an antenna provided by an embodiment of the present disclosure. FIG. 3 is a top view of an antenna provided by an embodiment of the present disclosure. FIG. 4 is a top view of an antenna provided by an embodiment of the present disclosure. As shown in FIGS. 1 to 4, the antenna includes a first dielectric substrate 1 and a second dielectric substrate 2, a phase adjustment structure between the first dielectric substrate 1 and the second dielectric substrate 2, a reference electrode layer 4 disposed on the first dielectric substrate 1, and at least one feeding structure 7. The reference electrode layer 4 is provided with at least one opening 10, and the phase adjustment structure is provided with a feeding end 501; the feeding structure 7 is electrically connected to the feeding end 501 of the phase adjustment structure through the opening 10. The opening 10 includes at least one first sub-structure 101, and a width of a middle portion of each first sub-structure 101 in at least part of first sub-structures 101 is not greater than a width of each of two ends of the first sub-structure 101 in a length direction of the first sub-structure 101.

With continued reference to FIG. 1, the reference electrode layer 4 is located on a side of the first dielectric substrate 1 away from the second dielectric substrate 2; the antenna further includes a third dielectric substrate 3 on a side of the reference electrode layer 4 away from the first dielectric substrate 1; the feeding structure 7 is on a side of the third dielectric substrate 3 away from the reference electrode layer 4. By additionally providing the third dielectric substrate 3, an electrode layer or the feeding structure 7 may be formed on a surface of the dielectric substrate without adopting a double-sided process, so that the difficulty of the process is greatly reduced. In the fabrication, the first dielectric substrate 1 has a thickness greater than that of the reference electrode layer 4.

In some implementations, the phase adjustment structure includes: a first electrode layer 5 on a side of the first dielectric substrate 1 proximal to the second dielectric substrate 2, a second electrode layer 6 on a side of the second dielectric substrate 2 proximal to the first dielectric substrate 1, and a tunable dielectric layer 8 between the first electrode layer 5 and the second electrode layer 6. The tunable dielectric layer 8 may be a liquid crystal layer, which is deflected at a certain voltage to shift the phase of the signal.

The antenna in the embodiment of the present disclosure may be an antenna based on a liquid crystal phase shifter. The opening 10 is configured to couple a signal from the feeding structure 7 to the feeding end 501 of the phase adjustment structure, and the opening 10 includes at least one first sub-structure 101, and the width of the middle portion of at least one first sub-structure 101 in the length direction of the first sub-structure 101 is less than the width of each of two ends of the first sub-structure 101. The opening 10 may be formed by one or more first sub-structures 101, which may be specifically adjusted according to an actual application scenario.

In some examples, with continued reference to FIG. 4, the phase adjustment structure includes two feeding ends 501, that is, a first feeding end and a second feeding end, and the reference electrode layer 4 includes two openings 10, that is, a first opening 11 and a second opening 12; the antenna includes two feeding structures 7, that is, a first feeding structure 701 and a second feeding structure 702; the first feeding structure 701 is electrically connected to the first feeding end through the first opening 11, and the second feeding structure 702 is electrically connected to the second feeding end through the second opening 12. The first feeding structure 701 may be configured to input a signal into the first feeding end of the phase adjustment structure, so that the phase adjustment structure shifts the phase of the signal, and the second feeding structure 702 is configured to receive an output signal that is phase-shifted by the phase adjustment structure and is transmitted by the first feeding end, and transmit the signal to a corresponding position.

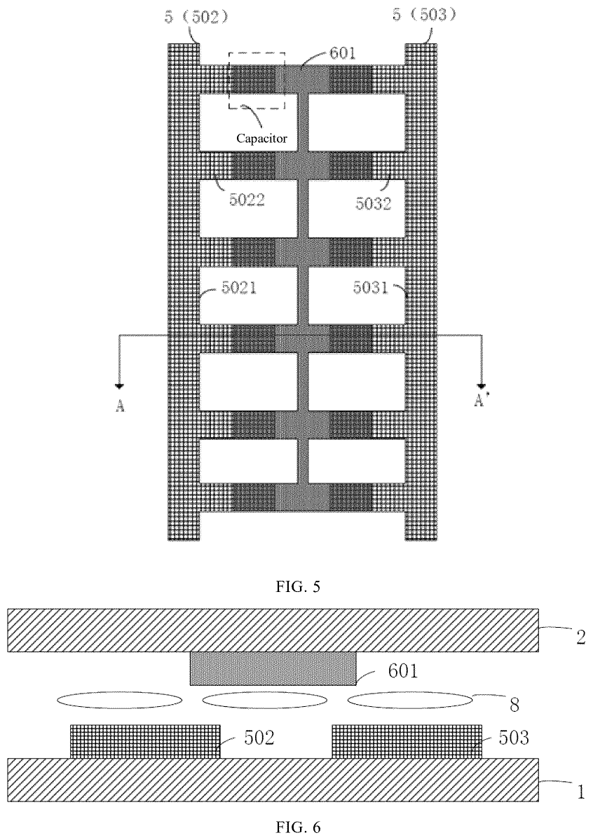

FIG. 5 is a top view of a phase adjustment structure in an embodiment of the present disclosure. FIG. 6 is a cross-sectional view taken along a direction A-A′ in FIG. 5. As shown in FIGS. 5 and 6, the first electrode layer 5 includes a first transmission structure and a second transmission structure, and a first transmission line 502 and a second transmission line 503; a main path of the first transmission structure is used as the first feeding end, and two branches of the first transmission structure are respectively connected to a first end of the first transmission line 502 and a first end of the second transmission line 503; a main path of the second transmission structure serves as the second feeding end, and two branches of the second transmission structure are respectively connected to a second end of the first transmission line 502 and a second end of the second transmission line 503. The second electrode layer 6 includes a plurality of patch electrodes 601, and an orthographic projection of each patch electrode 601 on the first dielectric substrate 1 overlaps with an orthographic projection of each of the first transmission line 502 and the second transmission line 503 on the first dielectric substrate 1. An end of the second electrode layer 6 proximal to the first transmission structure or the second transmission structure is connected to a reference voltage, and the patch electrodes 601 of the second electrode layer 6 may be connected together by one signal line and are all applied with the reference voltage. The patch electrodes 601 and the transmission lines form capacitors, so that the liquid crystals between the patch electrodes 601 and the transmission lines deflect, thereby realizing phase shift.

In some implementations, with continued reference to FIG. 3, in order to ensure that the feeding structure 7 can effectively couple signals to the feeding end 501 of the phase adjustment structure through the opening 10, a distance D between an edge of the device and a position NI at which the feeding structure 7, the feeding end 501 and the opening 10 coincide with each other should be greater than or equal to λ/2. In some implementations, D=λ/2, so that the feeding structure 7 has an optimal effect of coupling the signal to the feeding end 501.

It should be noted that the first transmission structure and the second transmission structure may be Balun components, or other structures, which is not further limited herein.

In some implementations, with continued reference to FIGS. 5 and 6, the first transmission line 502 includes a first main line 5021 and a plurality of first branches 5022 connected on one side of the first main line 5021 in an extending direction of the first main line 5021, and the second transmission line 503 includes a second main line 5031 and a plurality of second branches 5032 connected on one side of the second main line 5031 in an extending direction of the second main line 5031. The orthographic projection of each patch electrode 601 on the first dielectric substrate 1 overlaps with orthographic projections of one first branch 5022 and one second branch 5032 on the first dielectric substrate 1. The first transmission line 502 and the second transmission line 503 are provided with the plurality of branches for forming the capacitors with the patch electrodes 601, so as to form an increased capacitance by the capacitors, without affecting signal transmission on the first transmission line 502 and the second transmission line 503.

In some implementations, the antenna according to the embodiment of the present disclosure, with reference to FIGS. 2 to 4, includes a first dielectric substrate 1 and a second dielectric substrate 2, a phase adjustment structure between the first dielectric substrate and the second dielectric substrate 2, a reference electrode layer 4 disposed on the first dielectric substrate 1, and at least one feeding structure 7. The reference electrode layer 4 is provided with at least one opening 10, and the phase adjustment structure is provided with a feeding end 501; the feeding structure 7 is electrically connected to the feeding end 501 of the phase adjustment structure through the opening 10. The opening 10 includes at least one first sub-structure 101, and a width of a middle portion of each first sub-structure in at least part of first sub-structures 101 is not greater than a width of each of two ends of the first sub-structure 101 in a length direction of the first sub-structure 101.

In some implementations, the phase adjustment structure includes: a second electrode layer 6 on a side of the first dielectric substrate 1 proximal to the second dielectric substrate 2, a first electrode layer 5 on a side of the second dielectric substrate 2 proximal to the first dielectric substrate 1, and a tunable dielectric layer 8 between the first electrode layer 5 and the second electrode layer 6. The second electrode layer 6 serves as the reference electrode layer 4. By adopting the structure in the embodiment of the present disclosure, one dielectric substrate can be saved, resulting in a reduced number of dielectric substrates, so that the device is entirely more compact, which facilitates the miniaturization of the microwave component, and can save a space to integrate other devices into the device. Because the feeding structure 7 and the feeding end 501 of the phase adjustment structure are separated from each other by only one dielectric substrate, the feeding effect is better, and the loss is lower.

The antenna in the embodiment of the present disclosure may be an antenna based on a liquid crystal phase shifter. The opening 10 is configured to couple a signal from the feeding structure 7 to the feeding end 501 of the phase adjustment unit, and the opening 10 includes at least one first sub-structure 101, and the width of the middle portion of at least one first sub-structure 101 in the length direction of the first sub-structure 101 is less than the width of each of two ends of the first sub-structure 101. The opening 10 may be formed by one or more first sub-structures 101, which may be specifically adjusted according to an actual application scenario.

In some examples, with continued reference to FIG. 4, the phase adjustment structure includes two feeding ends 501, that is, a first feeding end and a second feeding end, and the reference electrode layer 4 includes two openings 10, that is, a first opening 11 and a second opening 12; the antenna includes two feeding structures 7, that is, a first feeding structure 701 and a second feeding structure 702; the first feeding structure 701 is electrically connected to the first feeding end through the first opening 11, and the second feeding structure 702 is electrically connected to the second feeding end through the second opening 12. The first feeding structure 701 is configured to input a signal into the first feeding end of the phase adjustment structure, so that the phase adjustment structure shifts the phase of the signal, and the second feeding structure 702 is configured to receive an output signal that is phase-shifted by the phase adjustment structure and is transmitted by the first feeding end, and transmit the signal to a corresponding position.

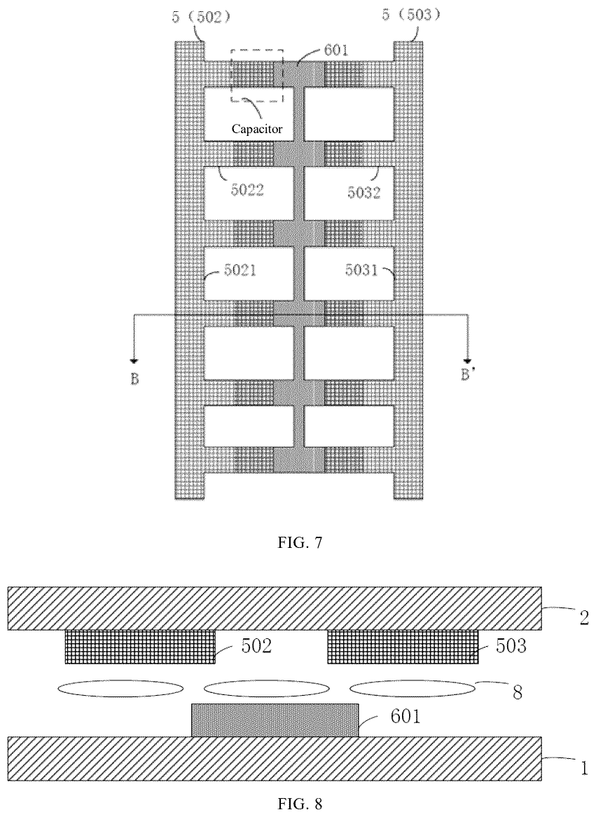

FIG. 7 is a top view of a phase adjustment structure in an embodiment of the present disclosure. FIG. 8 is a cross-sectional view taken along a direction B-B′ in FIG. 7. As shown in FIGS. 7 and 8, the first electrode layer 5 includes a first transmission structure and a second transmission structure, and a first transmission line 502 and a second transmission line 503; a main path of the first transmission structure is used as the first feeding end, and two branches of the first transmission structure are respectively connected to a first end of the first transmission line 502 and a first end of the second transmission line 503; a main path of the second transmission structure serves as the second feeding end, and two branches of the second transmission structure are respectively connected to a second end of the first transmission line 502 and a second end of the second transmission line 503. The second electrode layer 6 includes a plurality of patch electrodes 601, and an orthographic projection of each patch electrode 601 on the first dielectric substrate 1 overlaps with an orthographic projection of each of the first transmission line 502 and the second transmission line 503 on the first dielectric substrate 1. An end of the second electrode layer 6 proximal to the first transmission structure or the second transmission structure is connected to a reference voltage, and the patch electrodes 601 of the second electrode layer 6 may be connected together by one signal line and are all applied with the reference voltage. The patch electrodes 601 and the transmission lines form capacitors, so that the liquid crystals between the patch electrodes 601 and the transmission lines deflect, thereby realizing phase shift.

In some implementations, with continued reference to FIG. 3, in order to ensure that the feeding structure 7 can effectively couple signals to the feeding end 501 of the phase adjustment structure through the opening 10, a distance D between an edge of the device and a position NI at which the feeding structure 7, the feeding end 501 and the opening 10 coincide with each other should be greater than or equal to λ/2. In some implementations, D=λ/2, so that the feeding structure 7 has an optimal effect of coupling the signal to the feeding end 501.

It should be noted that the first transmission structure and the second transmission structure may be Balun components, or other structures, which is not further limited herein.

In some implementations, the first transmission line 502 includes a first main line 5021 and a plurality of first branches 5022 connected on one side of the first main line 5021 in an extending direction of the first main line 5021, and the second transmission line 503 includes a second main line 5031 and a plurality of second branches 5032 connected on one side of the second main line 5031 in an extending direction of the second main line 5031. The orthographic projection of each patch electrode 601 on the first dielectric substrate 1 overlaps with an orthographic projection of each of one first branch 5022 and one second branch 5032 on the first dielectric substrate 1. The first transmission line 502 and the second transmission line 503 are provided with the plurality of branches for forming the capacitors with the patch electrodes 601, so as to form an increased capacitance by the capacitors, without affecting signal transmission on the first transmission line 502 and the second transmission line 503.

It should be noted that the two structures of the antenna are exemplary structures, and may be adjusted according to actual situations, for example, a fourth dielectric substrate is disposed on a side of the second dielectric substrate 2 away from the first dielectric substrate 1, a radiation portion is disposed on the fourth dielectric substrate, and the phase-shifted signal is coupled to the radiation portion through the opening 10 for the antenna transmitting the signal. Alternatively, the phase adjustment structure is optimized, or the number of substrates or the structure of any electrode layer is changed. Two exemplary implementations are provided herein, not for a specific limitation.

It should be noted that materials of the feeding structure 7, the reference electrode layer 4, the first electrode layer 5 and the second electrode layer 6 may be one or more of metal materials, with relatively low resistance and relatively low loss, such as copper, gold and silver. The feeding structure 7, the reference electrode layer 4, the first electrode layer 5 and the second electrode layer 6 may be formed by magnetron sputtering, thermal evaporation or electroplating or a combination thereof. For example, a seed layer is formed by sputtering, and an electrode layer is formed by thickening the seed layer by electroplating. The first dielectric substrate 1, the second dielectric substrate 2 and the third dielectric substrate 3 may be made of common PCB insulation boards such as a polytetrafluoroethylene glass fiber laminated board, a phenol formaldehyde paper laminated board and a phenol formaldehyde glass cloth laminated board, or may be made of hard materials, with relatively low microwave loss, such as quartz, high temperature glass and common glass. The materials of different dielectric substrates may be the same or different, and specific materials are not specifically limited herein, and may be adjusted by one of ordinary skill in the art according to actual conditions. Besides the liquid crystal material, the tunable dielectric layer 8 may be made of other dielectric, with a tunable dielectric constant, such as graphene. A thickness and a specific material of the tunable dielectric layer 8 may be adjusted according to actual conditions, and are not particularly limited.

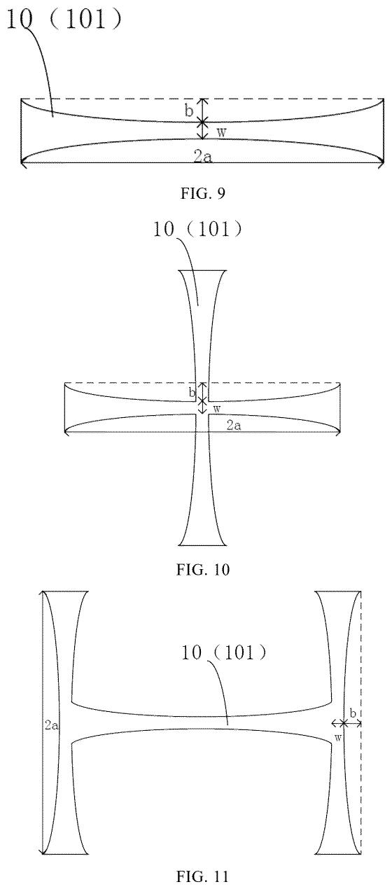

FIGS. 9 to 13 are top views of an opening provided by an embodiment of the present disclosure. As shown in FIGS. 9 to 13, the first sub-structure 101 is a straight-line structure, and includes a first side and a second side which extend in a length direction of the first sub-structure 101 and are disposed oppositely to each other; at least one of the first side and the second side is of a curved line or a broken line. In response to the first side and/or the second side being of a curved line, the first side and/or the second side may be an arc, a parabola, or a hyperbola (both the first side and the second side being curved lines), or may be a broken line. In response to the opening 10 being provided with a plurality of first sub-structures 101, first sides and second sides of part of the first sub-structures 101 may be of straight lines.

In some examples, with continued reference to FIG. 3, an orthographic projection of the feeding end 501 on the first dielectric substrate 1 passes through a middle portion of an orthographic projection of one of the first sub-structures 101 on the first dielectric substrate 1. In order to improve the feeding effect, a position at which the orthographic projection of the feeding end 501 on the first dielectric substrate 1 and the orthographic projection of the feeding structure 7 on the first dielectric substrate 1 coincide with each other at least corresponds to the middle portion of one first sub-structure 101. In response to the first side and/or the second side of the first sub-structure 101 being of a broken line, an inflection point of the broken line is at the middle portion of the first sub-structure 101, and in response to the first side and/or the second side of the first sub-structure 101 being of an arc, an arc top of the arc is at the middle portion of the first sub-structure 101.

In some examples, as shown in FIG. 9, the opening 10 includes two first sub-structures 101; middle portions of the two first sub-structures 101 intersect with each other, and a width of the middle portion of each first sub-structure 101 is not greater than a width of each of two ends of the first sub-structure 101 in a length direction of the first sub-structure 101. In order to improve the feeding effect, the position at which the orthographic projection of the feeding end 501 on the first dielectric substrate 1 and the orthographic projection of the feeding structure 7 on the first dielectric substrate 1 coincide with each other corresponds to the middle portion of one first sub-structure 101. Taking the first side and the second side of the first sub-structure 101 being of arcs as an example, the arc top of each of the arcs is at the middle portion of the first sub-structure 101 in the length direction of the first sub-structure 101.

In some implementations, as can be seen from a shape of the orthographic projection of the first sub-structure 101 on the first dielectric substrate 1, the first sub-structure 101 includes a concave region on each side of the orthographic projection of the first sub-structure 101 on the first dielectric substrate 1, because the first side and the second side of the first sub-structure 101 are of arcs. A length of the first sub-structure 101 is 2a, a maximum width of the concave region of the orthographic projection of the first sub-structure 101 on the first dielectric substrate 1 is b, and a width of the narrowest portion of the first sub-structure 101 is w. In this example, the narrowest portion of the first sub-structure 101 is at the middle thereof, and thus a width of the middle portion is w. In order to ensure the coupling effect between the feeding structure 7 and the feeding end 501 of the phase adjustment structure of the antenna, λ≥a>b≥λ/100, and λ/2≥w≥λ/100 are desired; λ is a dielectric wavelength corresponding to a center frequency f of the antenna being operating. By providing only one first sub-structure 101, the manufacturing process is simplified, but the coupling effect is relatively weak, which is suitable for microwave components with a relatively narrow bandwidth. In response to the antenna or other microwave components each being a component with a relatively narrow bandwidth, the first sub-structure 101 being of a straight-line may be formed, so that the manufacturing process is simpler without affecting the effect of the component.

In some examples, as shown in FIG. 10, the opening 10 includes two first sub-structures 101; middle portions of the two first sub-structures 101 intersect with each other, and a width of the middle portion of each first sub-structure 101 is not greater than a width of each of two ends of the first sub-structure 101 in a length direction of the first sub-structure 101. In order to improve the feeding effect, the position at which the orthographic projection of the feeding end 501 on the first dielectric substrate 1 and the orthographic projection of the feeding structure 7 on the first dielectric substrate 1 coincide with each other corresponds to the position at which the two first sub-structures 101 intersect with each other. Taking the first side and the second side of the first sub-structure 101 being of arcs as an example, the arc top of each of the arcs is at the middle portion of the first sub-structure 101 in the length direction of the first sub-structure 101.

In some implementations, as can be seen from a shape of the orthographic projection of each of the two first sub-structure 101 on the first dielectric substrate 1, each first sub-structure 101 includes a concave region on each side of the orthographic projection of the first sub-structure 101 on the first dielectric substrate 1, because the first side and the second side of the first sub-structure 101 are of arcs. A length of each first sub-structure 101 is 2a, a maximum width of the concave region of the orthographic projection of the first sub-structure 101 on the first dielectric substrate 1 is b, and a width of the narrowest portion of the first sub-structure 101 is w. In this example, the narrowest portion of the first sub-structure 101 is at the middle thereof, and thus a width of the middle portion is w, the middle portions of the two first sub-structures 101 intersect with each other, and the two first sub-structures 101 are perpendicular to each other; alternatively, a certain angle may be included between the two first sub-structures 101, for example, the acute angle of 45°, 60° or other angle may be included between the two first sub-structures 101, and the position at which the two first sub-structures 101 intersect with each other may be not at the middle portion, only an example is given, and the specific design may be adjusted according to actual expectations. In order to ensure the coupling effect between the feeding structure 7 and the feeding end 501 of the phase adjustment structure of the antenna, λ≥a>b≥λ/100, and λ/2≥w≥λ/100 are desired; λ is a dielectric wavelength corresponding to a center frequency f of the antenna being operating. Compared with proving one first straight-line sub-structure 101 of a straight-line, providing two first sub-structures 101 intersecting with each other can achieve a better coupling effect and an improved coupling strength, and thus is applicable to an antenna or microwave component with a relatively larger bandwidth; and compared with the traditional H-shaped slit, the manufacturing process is simplified.

In some examples, the opening 10 is an H-shaped opening 10, that is, includes three first sub-openings 10, a width of a middle portion of at least one first sub-structure 101 is not greater than a width of each of two ends of the first sub-structure 101 in a length direction of the first sub-structure 101. The H-shaped slit in the existing art includes three rectangles, but in the present disclosure, the H-shaped opening 10 is formed by the three first sub-structures 101, the width of the middle portion of at least one first sub-structure 101 in the length direction of the first sub-structure is not greater than the width of each of two ends of the first sub-structure 101.

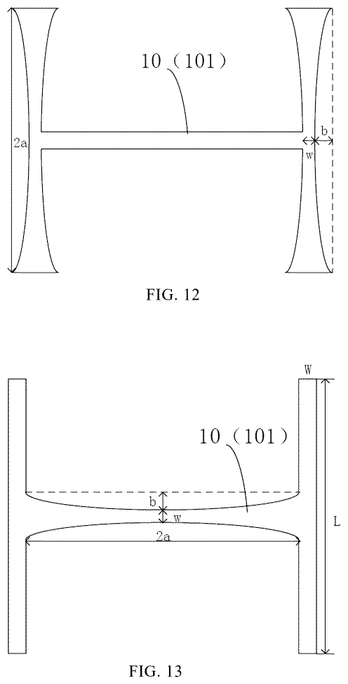

In some examples, as shown in FIG. 11, the H-shaped opening 10 includes three first sub-structures 101, and a width of a middle portion of each first sub-structure 101 in the three first sub-structures 101 of the H-shaped opening 10 is not greater than a width of each of two ends of the first sub-structure 101 in a length direction of the first sub-structure 101. For the three first sub-structures 101 of the H-shaped opening 10, two first sub-structures 101 are parallel to each other, one first sub-structure 101 is between the two first sub-structures 101 parallel to each other, and two ends of the first sub-structure 101 between the two first sub-structures 101 parallel to each other respectively overlap with the middle portions of the two first sub-structures 101 parallel to each other. In order to improve the feeding effect, a position at which the orthographic projection of the feeding end 501 on the first dielectric substrate 1 and the orthographic projection of the feeding structure 7 on the first dielectric substrate 1 coincide with each other corresponds to a middle portion of the first sub-structure 101 in the middle among the three first sub-structures 101.

In some implementations, as can be seen from a shape of the orthographic projection of each of the three first sub-structures 101, on the first dielectric substrate 1, each first sub-structure 101 includes a concave region on each side of the orthographic projection of the first sub-structure 101 on the first dielectric substrate 1, because the first side and the second side of the first sub-structure 101 are of arcs. A length of the first sub-structure 101 is 2a, a maximum width of the concave region of the orthographic projection of the first sub-structure 101 on the first dielectric substrate 1 is b, and a width of the narrowest portion of the first sub-structure 101 is w. In this example, the narrowest portion of the first sub-structure 101 is at the middle thereof, and thus a width of the middle portion is w. In order to ensure the coupling effect between the feeding structure 7 and the feeding end 501 of the phase adjustment structure of the antenna, λ≥a>b≥λ/100, and λ/2≥w≥λ/100 are desired; λ is a dielectric wavelength corresponding to ag center frequency f of the antenna being operating.

In some examples, as shown in FIG. 12, the H-shaped opening 10 includes three first sub-structures 101, and a width of a middle portion of each first sub-structure in the two first sub-structures 101 parallel to each other is not greater than a width of each of two ends of the first sub-structure 101 in a length direction of the first sub-structure 101. For the three first sub-structures 101 of the H-shaped opening 10, two first sub-structures 101 are parallel to each other, one first sub-structure 101 is between the two first sub-structures 101 parallel to each other, and two ends of the first sub-structure 101 between the two first sub-structures 101 parallel to each other respectively overlap with the middle portions of the two first sub-structures 101 parallel to each other. In order to improve the feeding effect, a position at which the orthographic projection of the feeding end 501 on the first dielectric substrate 1 and the orthographic projection of the feeding structure 7 on the first dielectric substrate 1 coincide with each other corresponds to a middle portion of the first sub-structure 101 in the middle among the three first sub-structures 101.

In some implementations, as can be seen from a shape of the orthographic projection of each of the two first sub-structures 101 parallel to each other on the first dielectric substrate 1, each first sub-structure 101 includes a concave region on each side of the orthographic projection of the first sub-structure 101 on the first dielectric substrate 1, because the first side and the second side of the first sub-structure 101 are of arcs. A length of each of the two first sub-structures 101 parallel to each other is 2a, a maximum width of the concave region of the orthographic projection of the first sub-structure 101 on the first dielectric substrate 1 is b, and a width of the narrowest portion of the first sub-structure 101 is w. In this example, the narrowest portion of the first sub-structure 101 is at the middle thereof, and thus a width of the middle portion is w. In order to ensure the coupling effect between the feeding structure 7 and the feeding end 501 of the phase adjustment structure of the antenna, λ≥a>b≥λ/100, and λ/2≥w≥λ/100 are desired; λ is a dielectric wavelength corresponding to a center frequency f of the antenna being operating.

In some examples, as shown in FIG. 13, the H-shaped opening 10 includes three first sub-structures 101, and a width of a middle portion of the first sub-structure 101 between the two first sub-structures 101 parallel to each other is not greater than a width of each of two ends of the first sub-structure 101 in a length direction of the first sub-structure 101. For the three first sub-structures 101 of the H-shaped opening 10, two first sub-structures 101 are parallel to each other, one first sub-structure 101 is between the two first sub-structures 101 parallel to each other, and two ends of the first sub-structure 101 between the two first sub-structures 101 parallel to each other respectively overlap with the middle portions of the two first sub-structures 101 parallel to each other. In order to improve the feeding effect, a position at which the orthographic projection of the feeding end 501 on the first dielectric substrate 1 and the orthographic projection of the feeding structure 7 on the first dielectric substrate 1 coincide with each other corresponds to a middle portion of the first sub-structure 101 in the middle among the three first sub-structures 101.

In some implementations, as can be seen from a shape of the orthographic projection of the first sub-structure 101 between the two first sub-structures 101, parallel to each other, on the first dielectric substrate 1, the first sub-structure 101 includes a concave region on each side of the orthographic projection of the first sub-structure 101 on the first dielectric substrate 1, because the first side and the second side of the first sub-structure 101 are of arcs. A length of the first sub-structure 101 between the two first sub-structures 101 parallel to each other is 2a, a maximum width of the concave region of the orthographic projection of the first sub-structure 101 on the first dielectric substrate 1 is b, and a width of the narrowest portion of the first sub-structure 101 is w. In this example, the narrowest portion of the first sub-structure 101 is at the middle thereof, and thus a width of the middle portion is w. In order to ensure the coupling effect between the feeding structure 7 and the feeding end 501 of the phase adjustment structure of the antenna, λ≥a>b≥λ/100, and λ/2≥w≥N/100 are desired; the two first sub-structures 101 parallel to each other each have a same size, and have a length of L, and a width of W; values of the length L and the width W each are in a reasonable range for effectively feeding, a range of the length L is λ/4≤L≤λ, and a range of the width W is λ/100≤W≤λ/5, and L>a>b. λ is a dielectric wavelength corresponding to a center frequency f of the antenna being operating. In some implementations, the value of the length L is λ/2, and the value of the width W is λ/20. In some implementations, the length 2a of the first sub-structure 101 between the two first sub-structures 101 parallel to each other is equal to a length L of each of the two first sub-structures 101 parallel to each other, and the maximum width b of the concave region of the orthographic projection of the first sub-structure 101 on the first dielectric substrate 1 is L/6.

In the embodiment of the present disclosure, for the H-shaped opening 10, a width of a middle portion of the first sub-structure 101 between the two first sub-structures 101 parallel to each other is not greater than a width of each of two ends of the first sub-structure 101 in a length direction of the first sub-structure 101. Compared with the H-shaped slit formed by three rectangular portions in the existing art, the H-shaped opening 10 provided in the embodiment of the present disclosure has the improved transmission coefficient and reflection coefficient during feeding. By applying the opening 10 in the embodiment of the present disclosure in the antenna for feeding, and performing experiments at an operating frequency of λ=10 Ghz, compared with the conventional H-shaped slit, the signal transmitted through the H-shaped opening 10 in the embodiment of the present disclosure is enhanced by about 1 dB, and a reflected signal is weakened by about 3 dB, which results in a weakened reflected signal, and an enhanced transmitted signal, thereby improving the feeding effect.

It should be noted that the designs of the openings 10 and the first sub-structures 101 provided in the present disclosure may be adjusted according to actual situations, and in the manufacturing process, the first sub-structure 101 in the opening 10 is formed into a structure being relatively narrow in the middle thereof and relative wide at the two ends thereof in the length direction of the first sub-structure 101, so as to improve the feeding effect, and simplify the manufacturing process on the basis of ensuring the feeding effect. The embodiment described above is merely an example, and may be changed and adjusted according to the actual circumstances. The opening 10 described above may be used in any microwave component for feeding.

In the embodiment of the present disclosure, the phase adjustment structure may be formed by following steps S1 to S5.

The step S1 includes: cleaning a dielectric substrate.

Specifically, the dielectric substrate is placed into a cleaning machine and cleaned by using chemical liquid and water to remove impurities and dirt on the surface thereof.

The step S2 includes: performing sputtering and electroplating processes on the dielectric substrate.

Specifically, a seed layer is sputtered on the dielectric substrate, and a thickness of the seed layer is increased by electroplating, so that an electrode layer is formed. A material of the electrode layer may be MTD-Cu, Mo—Al or Ag.

The step S3 includes: performing a patterning process.

Specifically, the dielectric substrate subjected to the above step is cleaned, and then is coated with glue such as a photoresist thereon; the electrode layer is patterned through exposure and development, and then the feeding structure 7, the first transmission structure and the second transmission structure are formed through operations of cleaning, post-baking, stripping and the like.

The step S4 includes: forming a support post.

Specifically, the support post is formed by using a patterning process and performing a height test.

The step S5 includes: injecting liquid crystal and performing aligning and assembling.

Specifically, two dielectric substrates are placed to be opposite to each other, and are aligned with each other by adopting, for example, a Rubbing means, which can align and assemble the two substrates opposite to each other with relatively high precision and relatively high quality. For the two substrates which are aligned and assembled, the glue is coated for fixing, then the liquid crystal is injected, and sealing adhesive is coated, and finally, a vacuum annealing process is performed, to finish the preparation.

It should be noted that, for forming a plurality of liquid crystal phase shifter antennas simultaneously, processes such as cutting and testing may be further be included. The above merely provides an exemplary process flow, which is not specifically limited here, and one of ordinary skill in the art may adjust the process and production procedures based on actual conditions.

The opening 10 provided for feeding in the embodiment of the present disclosure can enhance the coupling strength in the feeding process, and can expand an operating bandwidth of a phase shifter or any other type of antenna or microwave component. Compared with a metal waveguide, the air waveguide formed by the opening 10 has the characteristics of being relatively small in volume, easy to be integrated and easy to be miniaturized, and the transmission loss in the feeding process can be reduced through the design of the opening 10 and the first sub-structure 101 for forming the opening 10.

Based on the same inventive concept, an embodiment of the present disclosure further provides an electronic device including the antenna provided in the above embodiment. Therefore, a principle of solving the problem by the electronic device in the embodiment of the present disclosure is similar to a principle of solving the problem by the above antenna in the embodiment of the present disclosure. Based on this, the specific description of the electronic device in the embodiment of the present disclosure may be referred to the specific description of the above antenna, and will not be repeated.

It should be understood that the above embodiments are merely exemplary embodiments adopted to explain the principles of the present disclosure, and the present disclosure is not limited thereto. It will be apparent to one of ordinary skill in the art that various changes and modifications may be made therein without departing from the scope of the present disclosure, and such changes and modifications also fall within the scope of the present disclosure.

1. An antenna, comprising a first dielectric substrate and a second dielectric substrate, a phase adjustment structure between the first dielectric substrate and the second dielectric substrate, a reference electrode layer disposed on the first dielectric substrate, and at least one feeding structure,
wherein the reference electrode layer comprises at least one opening, the phase adjustment structure comprises a feeding end, and each feeding structure is electrically connected to the feeding end of the phase adjustment structure through one of the at least one opening, and
each of the at least one opening comprises at least one first sub-structure, and a width of a middle portion of each first sub-structure in at least part of first sub-structures is not greater than a width of each of two ends of the first sub-structure in a length direction of the first sub-structure.

2. The antenna according to claim 1, wherein an orthographic projection of the feeding end on the first dielectric substrate passes through a middle portion of an orthographic projection of one first sub-structure on the first dielectric substrate.

3. The antenna according to claim 1, wherein each of the at least one opening comprises two first sub-structures, middle portions of the two first sub-structures intersect with each other, and a width of the middle portion of each first sub-structure in the two first sub-structures is not greater than a width of each of two ends of the first sub-structure in a length direction of the first sub-structure.

4. The antenna according to claim 1, wherein each of the at least one opening is an H-shaped opening.

5. The antenna according to claim 4, wherein the H-shaped opening comprises three first sub-structures, and a width of a middle portion of each first sub-structure in the three first sub-structures of the H-shaped opening is not greater than a width of each of two ends of the first sub-structure in a length direction of the first sub-structure.

6. The antenna according to claim 4, wherein the H-shaped opening comprises three first sub-structures, and a width of a middle portion of each first sub-structure in two first sub-structures, parallel to each other, of the three first sub-structures is not greater than a width of each of two ends of the first sub-structure in a length direction of the first sub-structure.

7. The antenna according to claim 4, wherein the H-shaped opening comprises three first sub-structures, and a width of a middle portion of the first sub-structure between two first sub-structures parallel to each other is not greater than a width of each of two ends of the first sub-structure in a length direction of the first sub-structure.

8. The antenna according to claim 4, wherein the H-shaped opening comprises three first sub-structures, and two ends of the first sub-structure between two first sub-structures parallel to each other overlap with middle portions of the two first sub-structures parallel to each other, respectively.

9. The antenna according to claim 1, wherein each first sub-structure is a straight-line structure, and comprises a first side and a second side extending in a length direction of the first sub-structure and disposed oppositely to each other; and at least one of the first side and the second side is of a curved line or a broken line.

10. The antenna according to claim 1, wherein the reference electrode layer is on a side of the first dielectric substrate away from the second dielectric substrate; the antenna further comprises a third dielectric substrate, wherein the third dielectric substrate is on a side of the reference electrode layer away from the first dielectric substrate; and the feeding structure is on a side of the third dielectric substrate away from the reference electrode layer.

11. The antenna according to claim 10, wherein the phase adjustment structure comprises: a first electrode layer on a side of the first dielectric substrate proximal to the second dielectric substrate, a second electrode layer on a side of the second dielectric substrate proximal to the first dielectric substrate, and a tunable dielectric layer between the first electrode layer and the second electrode layer.

12. The antenna according to claim 1, wherein the phase adjustment structure comprises: a second electrode layer on a side of the first dielectric substrate proximal to the second dielectric substrate, a first electrode layer on a side of the second dielectric substrate proximal to the first dielectric substrate, and a tunable dielectric layer between the first electrode layer and the second electrode layer, and the second electrode layer serves as the reference electrode layer.

13. The antenna according to claim 11, wherein the phase adjustment structure comprises two feeding ends, comprising a first feeding end and a second feeding end, and the reference electrode layer comprises two openings, comprising a first opening and a second opening; the at least one feeding structure comprises a first feeding structure and a second feeding structure; the first feeding structure is electrically connected to the first feeding end through the first opening, and the second feeding structure is electrically connected to the second feeding end through the second opening;
the first electrode layer comprises a first transmission structure and a second transmission structure, and a first transmission line and a second transmission line; a main path of the first transmission structure serves as the first feeding end, and two branches of the first transmission structure are respectively connected to a first end of the first transmission line and a first end of the second transmission line; and a main path of the second transmission structure serves as the second feeding end, and two branches of the second transmission structure are respectively connected to a second end of the first transmission line and a second end of the second transmission line; and
the second electrode layer comprises a plurality of patch electrodes, and an orthographic projection of each of the patch electrodes on the first dielectric substrate overlaps with an orthographic projection of each of the first transmission line and the second transmission line on the first dielectric substrate.

14. The antenna according to claim 13, wherein the first transmission line comprises a first main line and a plurality of first branches connected on one side of the first main line in an extending direction of the first main line, and the second transmission line comprises a second main line and a plurality of second branches connected on one side of the second main line in an extending direction of the second main line; and
the orthographic projection of each of the patch electrodes on the first dielectric substrate overlaps with an orthographic projection of each of one first branch and one second branch on the first dielectric substrate.

15. An electronic device, comprising the antenna according to claim 1.

16. The antenna according to claim 2, wherein each first sub-structure is a straight-line structure, and comprises a first side and a second side extending in a length direction of the first sub-structure and disposed oppositely to each other; and at least one of the first side and the second side is of a curved line or a broken line.

17. The antenna according to claim 3, wherein each first sub-structure is a straight-line structure, and comprises a first side and a second side extending in a length direction of the first sub-structure and disposed oppositely to each other; and at least one of the first side and the second side is of a curved line or a broken line.

18. The antenna according to claim 4, wherein each first sub-structure is a straight-line structure, and comprises a first side and a second side extending in a length direction of the first sub-structure and disposed oppositely to each other; and at least one of the first side and the second side is of a curved line or a broken line.

19. The antenna according to claim 12, wherein the phase adjustment structure comprises two feeding ends, comprising a first feeding end and a second feeding end, and the reference electrode layer comprises two openings, comprising a first opening and a second opening; the at least one feeding structure comprises a first feeding structure and a second feeding structure; the first feeding structure is electrically connected to the first feeding end through the first opening, and the second feeding structure is electrically connected to the second feeding end through the second opening;
the first electrode layer comprises a first transmission structure and a second transmission structure, and a first transmission line and a second transmission line; a main path of the first transmission structure serves as the first feeding end, and two branches of the first transmission structure are respectively connected to a first end of the first transmission line and a first end of the second transmission line; and a main path of the second transmission structure serves as the second feeding end, and two branches of the second transmission structure are respectively connected to a second end of the first transmission line and a second end of the second transmission line; and
the second electrode layer comprises a plurality of patch electrodes, and an orthographic projection of each of the patch electrodes on the first dielectric substrate overlaps with an orthographic projection of each of the first transmission line and the second transmission line on the first dielectric substrate.
